(19) United States
(12) Patent Application Publication
(10) Pub. No.: US 2024/0284841 A1
(43) Pub. Date: Aug. 29, 2024

(54) A Subsurface Flood Irrigation System for trees and vines with use of devices having a trade

(71) Applicant: Taghi Amani, Neuchatel (CH)

(72) Inventor: Taghi Amani, Neuchatel (CH)

(21) Appl. No.: 18/573,984

(22) PCT Filed: Jun. 21, 2022
(86) PCT No.: PCT/IB2022/055764

§ 371 Date: Dec. 22, 2023

(30) Foreign Application Priority Data
Jun. 23, 2021 (CH) 00732/21

(51) Int. Cl. A01G 27/02; A01G 27/00; A01G 29/00

(52) U.S. Cl. CPC A01G 27/02; A01G 27/001; A01G 29/00

(57) ABSTRACT

A subsurface flood irrigation system for trees and vines with use of irrigation devices 100 having tank, with the ability to automatically store and drain the required water. In this system each irrigation devices 100 being connected in series with each other via a supply pipe 102. Each irrigation devices comprising: a) one tank 200, in the form of a cylindrical hollow space at an upper portion of the irrigation device, for storing the required water therein; b) one blocking chamber 300, located on the inside of the tank but at lower portion thereof, for blocking or opening one water drain vent; c) one air control system 500, positioned at the top inner portion of the tank, for blocking an air outlet path of one blocking chamber located in the next irrigation device; and, d) one hollow chamber 400, located at the lower portion of the irrigation device.

### BACKGROUND

The present invention relates to tree and vine irrigation systems.

More particularly, the present invention relates to tree and vine subsurface irrigation systems which deliver a certain amount of water to the root zones of trees and vines by the method of flooding.

Further, the present invention relates to tree and vine irrigation systems that have a water storage tank within each of their irrigation devices.

Also, the present invention relates to tree and vine irrigation systems in which the operation of storing water in tank of each irrigation devices, as well as the operation of drainage of water from each irrigation device to the root zone of tree and vine is automatic.

Furthermore, the present invention relates to tree and vine irrigation systems which provide an adjustable and controlled amount of water to the extent required by each tree and vine for its roots whereby uncontrolled and unwanted water abstraction by any tree or vine (due to, for example, variable water pressure in different parts of a land, soil type, etc.) is eliminated.

### STATE OF THE ART

There is no subsurface irrigation system with devices having a tank that can deliver a controllable amount of water to the root areas of trees and vines by the method of flooding.

There is no subsurface irrigation system for trees and vines with devices having a tank, in which the storage of water in their tank and the drainage of water from their tank is done automatically.

There is no subsurface irrigation system for trees and vines with devices having a tank, the amount of water storage in the tank of which can be adjustable.

Therefore, there is a need for a subsurface irrigation system for trees and vines with devices having a tank which can deliver a certain quantity, inter alia, of water to the root zone by a method of flooding.

Furthermore, there is a need for a subsurface irrigation system for trees and vines with tank, in which the storage of water in their tank and the drainage of water from their tank are done automatically.

Furthermore, there is a need for a subsurface irrigation system for trees and vines with devices having a tank, the amount of water storage in the tank of which is adjustable.

### OBJECTS AND FEATURES OF THE INVENTION

A primary object and feature of the present invention is to provide a tree or vine irrigation system.

It is a further object and feature of the present invention to deliver a certain amount of water to the root zones of trees by the method of flooding.

It is another object and feature of the present invention to provide such a system in which the amount of water required by each tree and vine can be adjustable and controllable and avoids uncontrolled and unwanted water abstraction by any tree (due to, for example, variable water pressure in different parts of a land, soil type, etc.).

It is yet another object and feature of the present invention to provide such a tree and vine irrigation system with the use of devices having tanks in which the operation of storing water inside these tanks and then water drainage is carried out automatically.

Another object and feature of the present invention is to introduce an irrigation system for trees and vines in which the irrigation operation is relatively rapid.

Finally, an object and feature of the present invention is to spread water over a wider radius into the root zone to prevent roots from concentrating at a certain point.

### SUMMARY OF THE INVENTION

In accordance with the present invention, an irrigation system is provided for irrigation tree and vine roots.

In this irrigation system, irrigation devices are used, each of which is installed vertically in the ground in relatively close association with the tree roots to provide irrigation and facilitated delivery of nutrients to the roots of a tree or vine. Irrigation devices may be installed at the time of initial planting, normally prior to backfilling the hole with the soil, or subsequently by placing each irrigation device into vertically elongated hole of selected depth.

Each said irrigation device comprising at least: a) one tank which is in a form of a cylindrical hollow space at an upper portion of the irrigation device and above one hollow chamber, for storing at least required water within the irrigation device; b) one blocking chamber, is located on the inside of the tank but at lower portion thereof, for blocking or opening one water drain vent. A blocking chamber is in the shape of a cylindrical space like an upside down glass attached to the bottom of the tank by the end of its side walls; That is, the bottom of the tank is as if the lid of a glass; c) one air control system, positioned at the top inner portion of the tank, for blocking an air outlet path of one blocking chamber located in the next irrigation device; and, d) one hollow chamber which is in the shape of a cylindrical hollow space, located at the lower portion of the irrigation device and below the tank, to eliminate direct contact between the water drain vent and soil or surrounding roots.

In the present irrigation system, in another case where the tank water is to be adjusted, tank water adjuster tube of different sizes is added with slight changes in the structure of the irrigation device, as is described in the following description.

Each irrigation devices in this system are connected to each other via a water supply pipe line and the first irrigation device is connected to both main water supply source and an air valve nearby the water supply source shut-off valve. In this system, the water first flows into the first irrigation device from the main water supply source and without being drained therefrom, the tank fills it with required water, then flows into the next irrigation device to fill it as well. This process continues until the last irrigation device is full. Then, to discharge the water stored in each irrigation devices, and after shutting off the water supply source shut-off valve, the air valve must be opened to release the air from the first irrigation device, in which case, the first irrigation device starts draining water in the root zone of the tree. Finally, all irrigation devices are drained one after the other.

The irrigation device in the present invention operates automatically while storing water in tanks and also draining the water at an appropriate time of discharging. The automatic operation of this system is based on the coordinated interaction of two pressures resulting from water accumulation on the one hand and air trapping on the other. In order to obtain this result, an air control system on the one hand and a blocking chamber on the other hand are used within each irrigation devices.

One said blocking chamber comprising: a) one closed upper end; b) one open lower end, which is connected to the bottom of the tank by the end of its sidewalls; c) at least one water inlet vent from the tank into the blocking chamber at the junction of the tank floor and the lower end of the blocking chamber adjacent to the water drain vent; The said water inlet vent allows water to enter the blocking chamber from the tank and then, after passing through the water drain vent, reach the root zone of a tree. d) one float which is located inside of blocking chamber and assists a blocker in blocking or opening the water drain vent; e) one blocker, preferably in the shape of an upside down cone, preferably made of rubber, which is fixed to the bottom of said float with a connecting shaft; f) one water drain vent, which is located on the bottom of the tank which is at the same time top end of one hollow chamber or in other words under the blocking chamber so that the blocker can be placed on it and block it; The diameter of said water drain vent can almost be in between of the diameter of the base and the vertex of the blocker and is structured and arranged to have at least two main functions: first, during storing water in said tank, it can easily completely block the water drain vent. second, when draining water from said irrigation device, it can easily come out of the drain vent and not get stuck inside thereof. g) one air hose, preferably thin with an internal diameter of about 3 mm, which starts from the top end of said blocking chamber and after passing through said tank reaches an air control system that is installed in the previous irrigation device. The air inside said blocking chamber is evacuated or blocked through this hose.

According to the above description, if a glass is placed upside down inside the water tank, obviously water will never enter the glass as long as the air is trapped inside it. The sealing chamber method is based on the same principle. When water enters the tank of the first irrigation device from the water supply source, it can enter the blocking chamber only if there is no more air left in it. On the contrary, it will not enter if the air within it is trapped. As mentioned above, the air inside of blocking chamber can be discharge through the air hose or blocked by it. Further, mentioned that the air hose is connected to an air control system. The function of the air control system is to block or release air from the blocking chamber through the air hose. In a situation where air is trapped in the blocking chamber, and because no water enters inside of it, a float inside the blocking chamber due to its relative weight, is placed in lower level, which causes the blocker which is attached to its bottom to be placed inside the water drain vent to block that vent.

One said air control system, which closes the air outlet of the blocking chamber through the air hose, consists of: a) an air chamber in the form of a vertical cylinder with two closed upper and lower ends. The said air hose, after extending from the blocking chamber, leads into it through one of those ends; b) an air nozzle, which has two ends; a lower end which is inserted vertically into the blocking chamber through the upper end the blocking chamber and an upper end, which remains outside the air chamber; c) a rubber piece to guarantee that one end of said air nozzle that is positioned inside the air chamber is blocked; d) a float; when the water in the tank is drained, the float should normally move downwards to separate the rubber piece from the air nozzle and cause air to release from the blocking chamber. But sometimes, the air pressure entering from the blocking chamber may be so high that the float cannot separate the rubber piece of the air nozzle blocker. and, e) a connecting bar with two ends, one end of which is connected to the said float and the other end is connected to the centre of the rubber piece after passing through the said air nozzle.

To prevent tank water from entering the air hose due to high water pressure inside the tank, the air hose can be connected to the lower end of the air chamber and a tiny ball can be left there; In such a way that the diameter of the tiny ball is larger than the diameter of the hose to get stuck in the opening of the hose due to water pressure and prevent water from entering the hose.

According to the mentioned parts in the air control system, when the tank is filled with water and reaches a level above the floating level, it causes the float to rise. As the float rises, the connecting bar also rises and pulls the rubber piece up as well, in such a way that it attaches the rubber piece firmly to the lower end of the air nozzle and completely blocks it, thus preventing air from releasing through it. Conversely, when the tank water is drained, the float also lowers, causing the interface bar to come down, resulting in the separation of the rubber piece from the air nozzle, in which case the air trapped inside the blocking chamber is also drained.

With the description given above, it can be found that before the water flows from one irrigation device into the next irrigation device, the air nozzle of the next irrigation device which is located in the previous irrigation device has already been sealed by its air control system. In such situation, when the air nozzle is sealed, the air inside the blocking chamber will also be trapped. When air is trapped inside the blocking chamber, water does not enter the blocking chamber. On the contrary, when the air valve is opened after closing the water supply source shut-off valve, the air trapped inside the blocking chamber of the first irrigation device will be released through the air hose of which is connected to the air valve. As the air in the blocking chamber of the irrigation device is released, water flows into the chamber from the tank, as a result, the float inside the blocking chamber rises and pulls the blocker upward until the blocker removes from water drain vent. In this way, water is drained to the root zone of the tree.

In the present invention, the amount of water in the tank of any irrigation device is adjustable. Adjusting the required water of each tree or vine to be stored in the tank can be done in two ways. The first method, wherein the tank for each irrigation device is interchangeable in size, that is, for instance, for a shrub, a tank with a capacity of 1 liter can be used, but for a larger tree, a tank with a capacity of, for example, 4 liters can be used. The second method, wherein the tank of all irrigation devices are the same size from the outset but for each tree according to the needs of that tree it has the possibility of reducing the storage capacity. For example, a tank with a capacity of 4 liters of water is installed from the outset, but for example, for a shrub is set at 1 liter, for a medium-sized tree at 3 liters and for another tree at 4 liters, so that each tree or vine receives the amount of water it needs in each irrigation cycle.

The said second method has been achieved by using tank water adjuster tube with different length that are directed into the tank from the top end of each irrigation device so that the tank is not filled with water more than the level of such water adjuster tube. This method to perform requires some slight changes in the irrigation device, so that a divider plate is used to create a separate specific space for the air control system out of the tank. This plate is like a secondary roof for the tank and like a floor for the air control system. Such divider plate assists to prevent the flow of air or water between the tank and the air control system.

From the surface of the divider plate, a water inlet tube is installed into the tank, which extends to the vicinity of the tank floor. In addition, in another part of the surface of the divider plate, there is another cylindrical tube which extends to the below portion of the roof of the irrigation device. Tank water adjuster tubes are movable inside this cylindrical tube, like the piston of a syringe.

Above mentioned tank water adjuster tube can be in different longitudinal sizes which is selectable for each desirable level of water storage in the tank. Such a tank water adjuster tube enters inside the irrigation device through a closable vent on top end of the irrigation device and then its lower part enters the tank through the mentioned cylindrical tube on the divider plate. Such a tank water adjuster tube comprising: a) one lower half the longitudinal size of which is changeable and passes through the mentioned cylindrical tube on the divider plate, to the inside of the tank; b) one upper half having a fixed longitudinal size, having some holes in one level on its side walls adjacent to its top end and the upper end edges of which are folded inwards in a manner to form one slot. the mentioned upper half does not pass through the cylindrical tube in the divider plate; c) one middle section on which a rubber gasket is attached (such as a rubber attached to a syringe piston) that guarantees the absence of probable leakage of air or water at the junction between the cylindrical tube wall of the divider plate and the regulating tube.

A cap, preferably that of a screw cap, which is removably attached to an opening on the top end of the irrigation device and provides at least access to the tank water adjuster tube for the replacement. Such a cap comprising: a) one sealing ring at the bottom in order for guaranteeing the absence of air or water leakage from inside of the irrigation device to the outside; b) one hooked rod that is attached to the centre of the bottom of the cap to assist in pull a tank water adjuster tube out of the irrigation device.

The cap has some basic functions, including: first, provides access to the tank water adjuster tube; second, guarantees the absence of air or water leakage from the inside of the irrigation device to the outside; third, assists in pulling the tank water adjuster tube out of the irrigation device. This result will be obtained by means of the hook which is attached to the bottom of the cap with the mentioned rod. Such hook enters the inside of the tank water adjuster tube through the slot provided in the top end of the tank water adjuster tube. After entering the hook into the tank water adjuster tube and after a slight rotation, the hook will get stuck with the folded inwards edges of the top end of the mentioned tube and then, with a little effort upwards, pulls the mentioned tube easily out of the irrigation device.

In accordance with one another preferred embodiment the present invention, wherein the amount of water in the tank is adjustable with use of tank water adjuster tube, the water after entering inside the irrigation device through an inlet tube located on one top corner thereof, it pours onto the separating plate then flows into the tank through a tube which extending into the tank from the floor of the divider plate. After filling the tank up to the level of the tank water adjuster tube, because of the air trapped in the tank above the space of such tank water adjuster tube, stops filling further water in the tank.

At the bottom of the irrigation device, there is a hollow chamber so that the upper end thereof is the lower end of the tank. The lower end of such a hollow chamber is a mesh plate, preferably spongy, to prevent dirt from entering the chamber. Such a chamber is intended to create a hollow space between the water drain vent of the irrigation device and the soil for disconnecting a direct interface between them.

To further guarantee a fully drain water from the tank, it is preferable to be put a float inside the hollow chamber so that the top end thereof can reach and touch the bottom end(vertex) of the blocker.

One suggested alternative to the bottom end of the hollow chamber, as replacement for the mesh plate, in order for dispersing water to more points nearby is that to attach a relatively horizontal or ring tube with more drain nozzles in different points thereof.

### BRIEF DESCRIPTION OF THE DRAWINGS

Examples of implementation of the invention are indicated in the description illustrated by the appended figures in which:

FIG. 1 shows a front view illustrating the use of a tree irrigation system according to a preferred embodiment of the present invention and also an overview of a pair of irrigation devices connected to together following the connection to a water source and to an air valve.

FIG. 2 shows a perspective view of a pair of irrigation devices without tank water adjuster cylindrical tube that are connected together.

FIG. 3 is a perspective view of a pair of irrigation devices with a portion of the sidewall structure broken away to illustrate constructions details of a blocking chamber.

FIG. 4 is a cross-sectional view of a blocking chamber illustrating a water drain vent, a blocker, a connecting shaft of blocker, a float, at least one water inlet vent, the bottom of the tank, and an air hose.

FIG. 5 is a view of a pair of irrigation devices with a portion of the sidewall structure broken away to indicate the location of an air control system.

FIG. 6 is a view of a pair of air control systems with a portion of the sidewall structure broken away to show their internal details. this figure shows them in two modes of blocking or releasing the air outlet through the air hose.

FIG. 7 shows an overview of a pair of irrigation devices wherein the water of its tank is adjustable.

FIG. 8 shows an overview of a irrigation device wherein the water of its tank is adjustable with a portion of the sidewall structure broken away to illustrate constructions details of a divider plate.

FIG. 9 is a view of the irrigation devices with a portion of the sidewall structure broken away to illustrate a perspective view of mounting of a tank water adjuster tube.

FIG. 10 is an overview of some preferable longitudinal sizes of tank water adjuster tube and its structure.

FIG. 11 shows a perspective view of the tank water adjuster tube in a position being assembled configuration in a irrigation device.

FIG. 12 shows an exploded perspective view of a preferable method of mounting a tank water adjuster tube in a irrigation device and also an overview of a cap which is to be screwed to an access vent on the top of the irrigation device.

FIG. 13 is a perspective view of two irrigation devices without a tank water adjuster tube which are interconnected, in a situation one of which is filled with water but to the other has not yet flowed.

FIG. 14 is a perspective view of two irrigation devices without a tank water adjuster tube which are interconnected, in a situation where the floats of their air control system are lowered and this has caused the trapped air to be released from the blocking chamber and the water drain vent to be opened.

FIG. 15 is a perspective view of two irrigation devices with tank water adjuster tube which are interconnected, in a situation where one is filled with water but water has not yet flowed into the latter.

FIG. 16 is a perspective view of two irrigation devices with tank water adjuster tube which are interconnected, in a situation where the floats of their air control system are lowered and this has caused the trapped air to be released from the blocking chamber and the water drain vent to be opened.

FIG. 17 is a view of hollow chamber with a portion of the sidewall structure broken away to illustrate constructions details thereof.

FIG. 18 shows a perspective view of a suggested alternative to the hollow chamber in order for dispersing water to more points.

FIG. 19 shows a perspective view of one more suggested alternative to the hollow chamber in order for dispersing water to more points.

FIG. 20 is a view of an indicator by which the fullness or emptiness of the tank can be detected.

### DETAILED DESCRIPTION OF THE BEST MODES AND PREFERRED EMBODIMENTS OF THE INVENTION

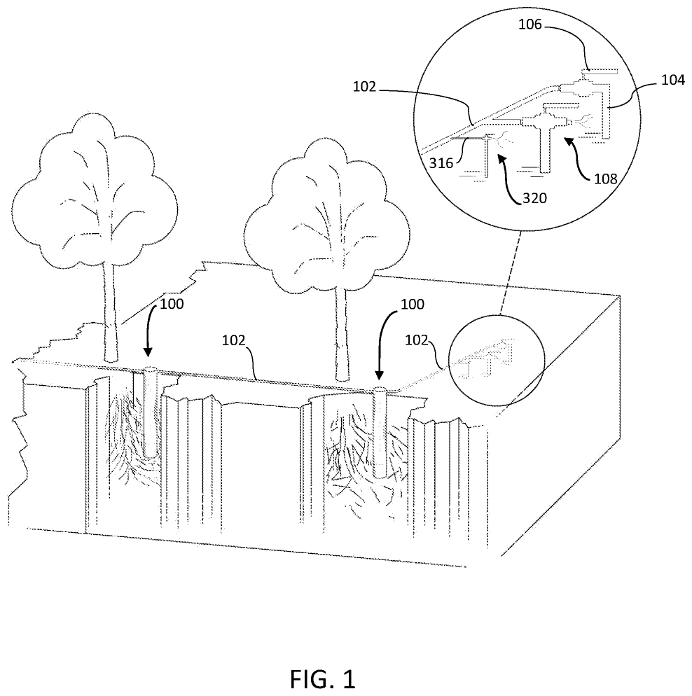

FIG. 1 shows a front view illustrating the use of a tree irrigation system according to a preferred embodiment of the present invention and an overview of a pair of irrigation devices connected to together following the connection to a water supply source and to an air valve.

In the irrigation system introduced by the present invention, irrigation devices 100 are used, as shown. FIG. 1 shows two irrigation devices 100 are installed vertically in the ground in relatively close association with the tree roots to provide irrigation and facilitated delivery of nutrients to the roots of a tree or vine. These irrigation devices may be installed at the time of initial planting, normally prior to backfilling the hole with the soil, or subsequently by placing each irrigation devices into vertically elongated hole of selected depth. The irrigation devices 100 in this system is connected to each other via a connecting pipe 102, so that water flows into each irrigation device 100 through that connecting pipe 102 and the first irrigation device is connected to both main water supply source 104 and an air valve 318 nearby the water supply source shut-off valve 106.

After each irrigation devices 100 is installed next to each tree or vine and after the first irrigation device is connected to a water supply source 104, and to a irrigation operation begins, a shut-off valve 106 of the water supply source 104 is opened to allow water flows into the first irrigation device 100. After the first irrigation device is filled, the water flows into the next irrigation device to fill it as well and similarly continues until the last irrigation device is filled. According to the present invention, when the shut-off valve 106 of the water supply source is opened (during the process of filling the irrigation devices), it is necessary to an air valve 320 adjacent the shut-off valve 106 be closed.

in order for the irrigation system to perform better in draining water, it is necessary that air circulates through the connecting pipe 102. To do so, either the connecting pipe must be detached from the water supply source 104 or that another air valve 108 is installed in such a way that it can be opened when draining the water from the irrigation devices.

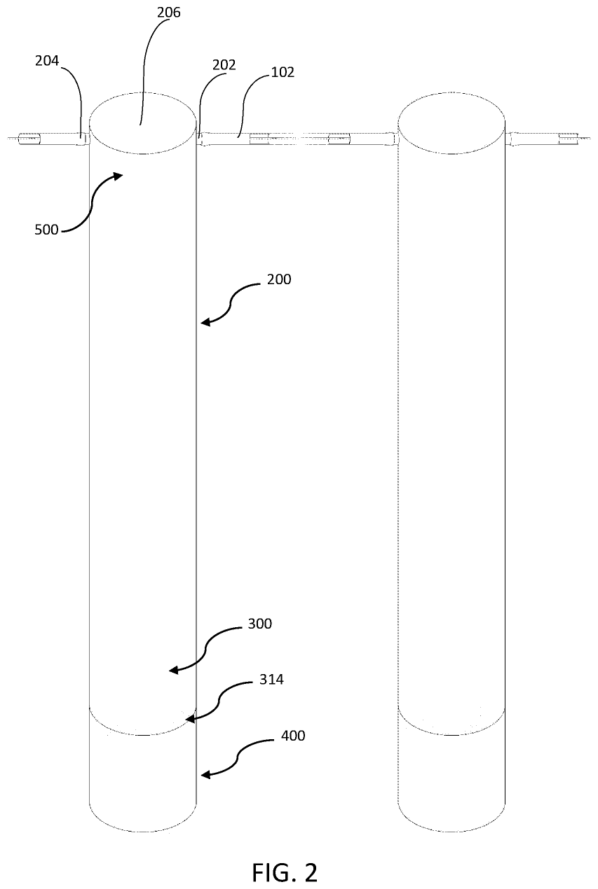

According to the present invention, the connecting pipe 102 can be either placed on the surface of the ground or buried in the ground. To be finely buried in the ground, the pipe 102, from the point of its connection 202 & 204 (FIG. 2) to the irrigation device is first bent vertically in parallel with the irrigation device 100 to the desired depth then is turned to a horizontal position.

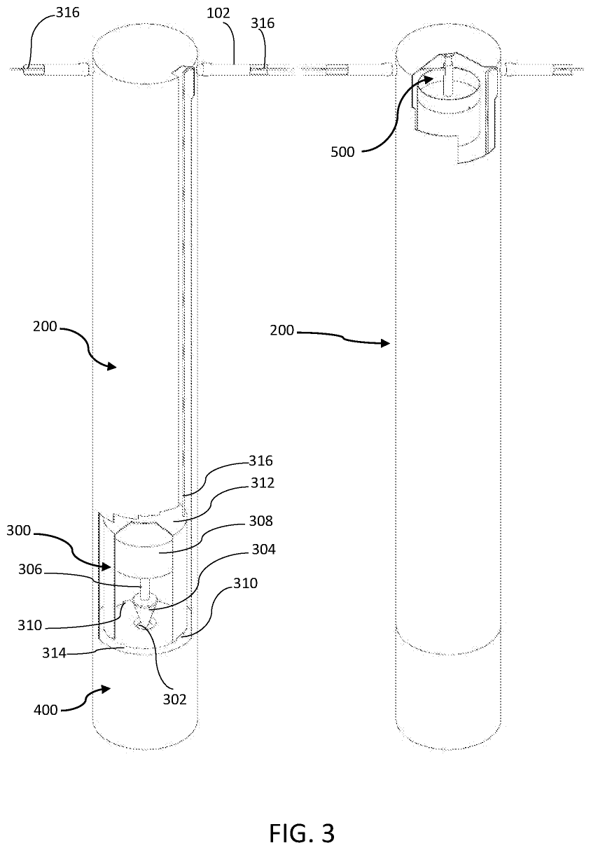

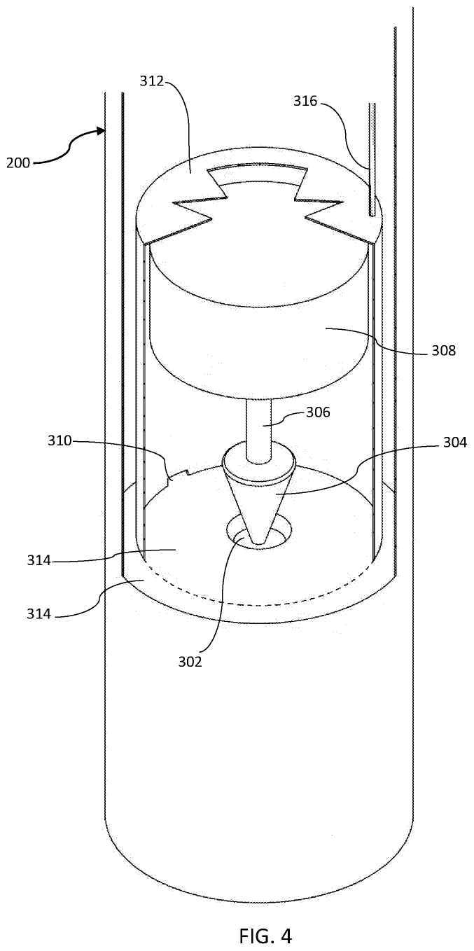

FIG. 2 shows a perspective view of a pair of irrigation devices without tank water adjuster cylindrical tube that are connected together. According to the preferred embodiment of the present invention, a irrigation device comprising: one tank 200, which is in a form of a cylindrical hollow space at an upper portion of the irrigation device and above one hollow chamber, for storing at least required water within the irrigation device, wherein the diameter and length of which, depending on the amount of water required for storage and the proximity to the roots of a tree or vine is changeable. For example, a tank 200, from 1 litre to 5 litres or even more depending on the need of a tree can be variable in capacity. A tank 200 comprising: one top end 206 which is closed without having a hole to towards the outside; one bottom end 314 which is connected to one top end of one hollow chamber 400 and has a water drain vent (302 as shown in FIGS. 3 and 4) in its centre; and, one inlet pipe 202 and one outlet pipe 204 each of which faces each other and is positioned adjacent to the top end 206. The irrigation device 100 further comprising one blocking chamber 300 (FIGS. 3 & 4), is located on the inside of the tank but at lower portion thereof, for blocking or opening one water drain vent. Furthermore, a irrigation device 100 comprising a hollow chamber 400 which is positioned under the tank 200 and has function of disconnecting between the ground and water drain vent. Moreover, a irrigation device 100 having an air control system 500 which is located on the top section of irrigation device 100 but below the top end of tank 200.

FIG. 3 is a perspective view of a pair of irrigation devices with a portion of the sidewall structure broken away to illustrate constructions details of a blocking chamber 300. A blocking chamber 300 is an another preferred embodiment of the present invention. A blocking chamber is in the shape of a cylindrical space like an upside down glass attached to the bottom 314 of the tank 200 by the end of its side walls; That is, the bottom of the tank is as if the lid of a glass. Such a blocking chamber 300 has the function of keeping the water drain vent 302 of each irrigation device 100 closed until the end of the water storage operation in all irrigation devices and then open for drainage. It will open this vent at an appropriate time, to drain the water stored in the reservoir to the root of the tree or vine.

One said blocking chamber comprising: a) one closed upper end 312; b) one open lower end, which is connected to the bottom of the tank by the end of its sidewalls; c) At least one water inlet vent 310 from the tank 200 into the blocking chamber at the junction of the tank floor 314 and the lower end of the blocking chamber adjacent to the water drain vent 302; The said water inlet vent allows water to enter the blocking chamber from the tank and then, after passing through the water drain vent, reach the root zone of a tree. d) one float 308 which is located inside of blocking chamber 300 and assists a blocker 304 in blocking or opening the water drain vent; e) one blocker 304, preferably in the shape of an upside down cone, preferably made of rubber, which is fixed to the bottom of said float with a connecting shaft 306; f) one water drain vent 302, which is located on the bottom of the tank 314 which is at the same time top end of one hollow chamber 400 or in other words under the blocking chamber so that the blocker can be placed on it and block it; The diameter of said water drain vent can almost be in between of the diameter of the base and the vertex of the blocker and is structured and arranged to have at least two main functions: first, during storing water in said tank, it can easily completely block the water drain vent. second, when draining water from said irrigation device, it can easily come out of the drain vent and not get stuck inside thereof. g) one air hose 316, preferably thin with an internal diameter of about 3 mm, which starts from the top end 312 of said blocking chamber and after passing through said tank reaches an air control system 500 that is installed in the previous irrigation device. The air hose of the first irrigation device is connected to an air valve 320 (FIG. 1). The air inside said blocking chamber is discharge or blocked through this hose.

As shown in FIG. 3, before the water enters the tank of a irrigation device, if the air hose 316 is blocked by the air control system 500 located in the previous irrigation device, in this case, air is trapped inside the blocking chamber 300 in which case the flow of water from the tank 200 into the blocking chamber is prevented. In such a case, the float 308, with its relative weight holds the blocker 304 on the drain vent 302 and that vent remains closed. On the contrary, when the air valve 320, as shown in FIG. 1, is opened after closing the water supply source shut-off valve 106, the air trapped inside the blocking chamber of the first irrigation device will be released through the air hose 316 connected to the air valve 320. As the air in the blocking chamber of the irrigation device is released, the water from the tank 100 flows into the blocking chamber 300, as a result of which the float 308 inside the blocking chamber rises and pulls the blocker 304 upward until the blocker 304 removes from that water drain vent 302. In this way, water is drained to the root zone of the tree.

FIG. 4 is a cross-sectional view of a blocking chamber illustrating a water drain vent 302, a blocker 304, a connecting shaft of blocker 306, a float 308, at least one water inlet vent 310, the bottom of the tank 314, and an air hose 316.

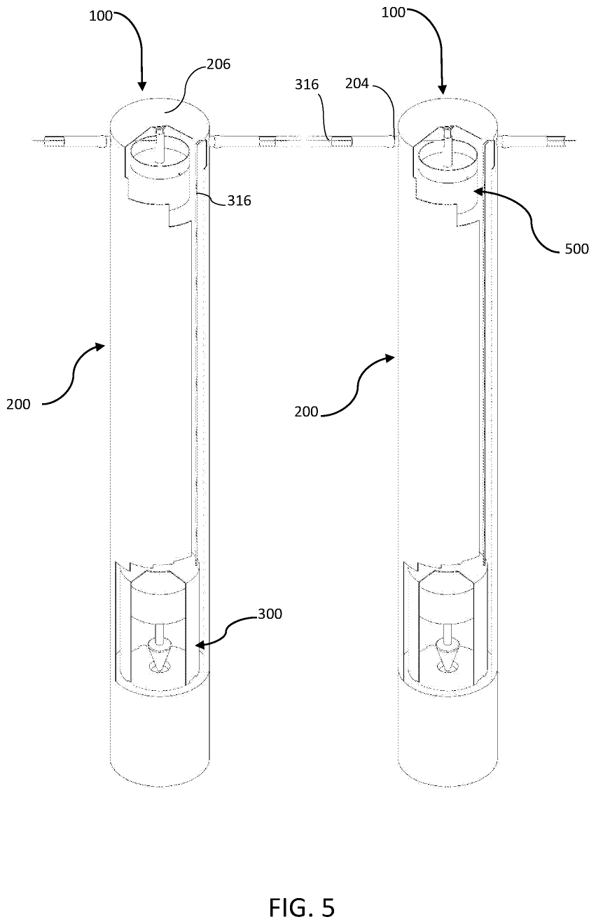

FIG. 5 is a view of a pair of irrigation devices with a portion of the sidewall structure broken away to indicate the location of an air control system. An air control system 500 is yet another preferred embodiment of the present invention which is located at the top inner portion of a irrigation device 100 below the top end 206 of tank 200. The air control system 500 has the function of blocking an air outlet path of one said blocking chamber 300 located in the next irrigation device. Blocking of the air outlet path, as shown in description of FIG. 3, causes an air trap inside the blocking chamber.

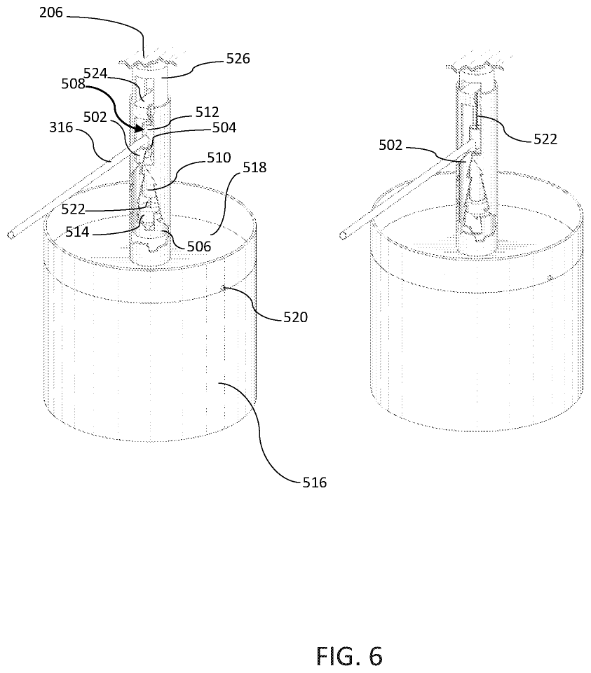

FIG. 6 is a view of a pair of air control systems with a portion of the sidewall structure broken away to show their internal details. This figure shows them in two modes of blocking or releasing the air outlet through the air hose which extended from the upper end of said blocking chamber.

An air control system 500 comprising: a) An air chamber 502 in the form of a vertical cylinder with two closed upper 504 and lower 506 ends. One air hose 316, after extending from the blocking chamber 300 (FIG. 5), leads into it 502 through one of those ends 504/506; b) An air nozzle 508, which has two ends; A lower end 510 which is inserted vertically into the air chamber 502 through the upper end 504 the air chamber and an upper end 512, which remains outside the air chamber; c) A rubber piece 514 to guarantee that one end of said air nozzle 510 that is positioned inside the air chamber is blocked; d) A float 516, to provide the force needed to place the rubber piece 514 on one end of the air nozzle 510 in order to block it. When the water in the tank is drained, the float should normally move downwards to separate the rubber piece 514 from the air nozzle 510 and cause air to release from the air chamber 502. But sometimes, the air pressure entering from the blocking chamber 300 (FIG. 5) might be so high that the float 516 cannot separate the rubber piece of the air nozzle blocker. This requires that the floating weight be relatively high when draining water from the tank 200 (FIG. 5). For this purpose, and to increase the temporary weight of the float 516 when draining water from the tank, a container 518 with a small hole 520 can be installed above the float 516 to temporarily hold water on top of the float and provide it with a little more weight. And, e) A connecting bar 522 with two ends, one end of which is connected to one part 524 of said float 516 and the other end is connected to the centre of the rubber piece 514 after passing through the said air nozzle 508;

According to the sections mentioned in the air control system 500, when the tank 200 (FIG. 5) is filled with water and reaches a level above the floating level, it causes the float 516 to rise. As the float rises, the connecting bar 522 also rises and pulls up the rubber piece 514 as well; In such a way that it attaches the rubber piece firmly to the lower end 510 of the air nozzle and blocks it completely, thus preventing air from escaping through it. On the contrary, when the tank water is drained, the float 516 also lowers, causing the connecting bar 522 to come down, resulting in the separation of the rubber piece 514 from the air nozzle 510 in which case, the air trapped inside the blocking chamber 300 (FIG. 5) is also discharged through the air hose 316.

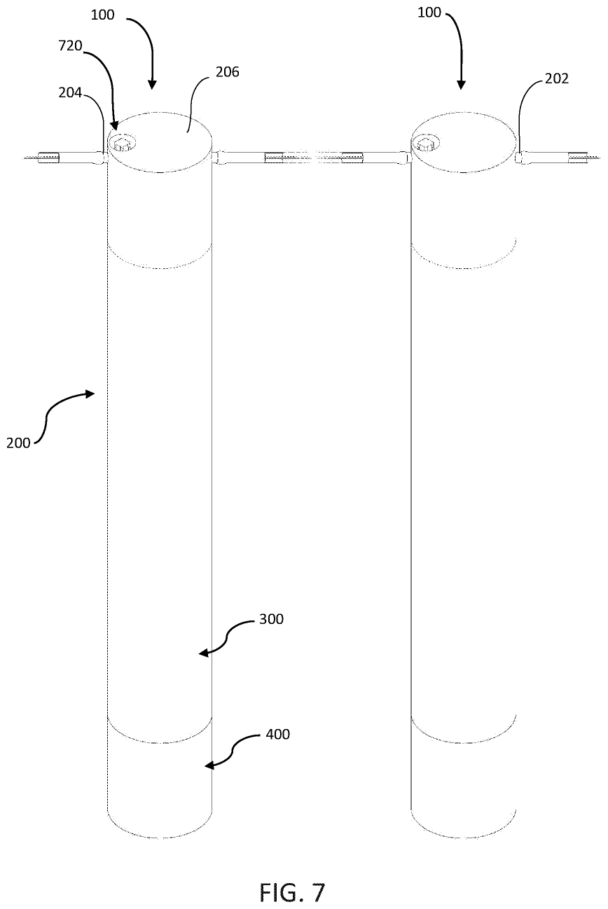

FIG. 7 shows a perspective view of a pair of irrigation devices wherein the required amount of water of is adjustable. According to the preferred embodiment of the present invention, a irrigation device according to the FIG. 7 comprising: one tank 200, which is in a form of a cylindrical hollow space at an upper portion of the irrigation device 100 and above one hollow chamber 400, for storing at least required water within the irrigation device, wherein the required amount of water of is adjustable. Said tank 200 comprising: One closed top end 206 wherein one access vent 700 with a cap 720, preferably a screw cap, is formed to provide at least access to a water control tube for replacement. one bottom end 314 which is connected to a hollow chamber 400; one inlet pipe 202 and one outlet pipe 204 each of which faces each other and is positioned adjacent to the top end 206. The irrigation device 100 further comprising one blocking chamber 300 (FIGS. 3 & 4), is located on the inside of the tank 200 but at lower portion thereof, for blocking or opening one water drain vent. Furthermore, a irrigation device 100 comprising one hollow chamber 400 which is positioned under the tank 200 and has function of disconnecting between the ground and water drain vent. Moreover, a irrigation device 100 having an air control system 500 which is located on the top section of irrigation device 100 but below the top end of tank 200.

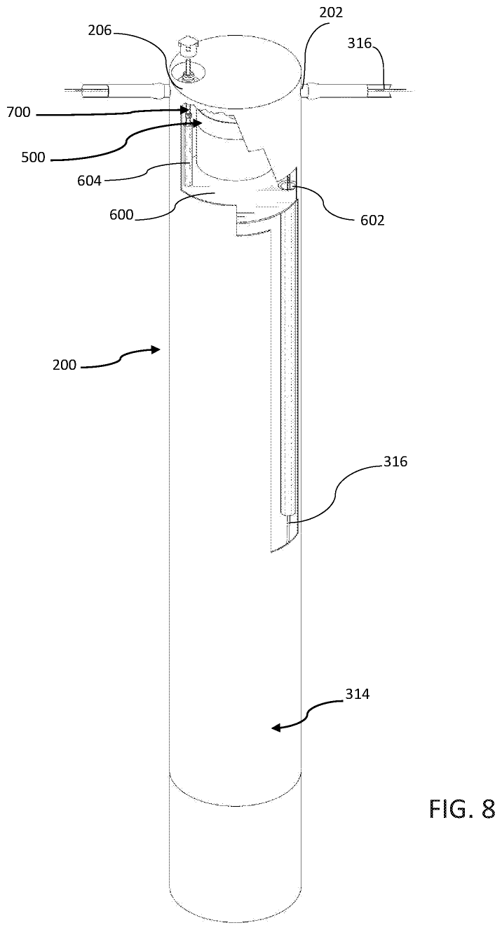

FIG. 8 shows an overview of a irrigation device wherein the water of its tank is adjustable with a portion of the sidewall structure broken away to illustrate constructions details of a divider plate. According to the preferred embodiment of the present invention based on FIG. 8, a divider plate 600 is used to create a separate specific space for the air control system 500 out of the tank 200. There is no connection between over and under of the divider plate except through a tube 602 that extends from the bottom of the plate into the tank.

This plate 600 is like a secondary roof for the tank 200 and like a floor for the air control system 500. From the bottom of the divider plate 600 a water inlet tube 602 is installed into the tank 200 that extends to the vicinity of the tank floor. This tube is for that the incoming water to the irrigation devices is directed into the tank through this tube 602. Also, the air hose 316 in this type of irrigation device passes through this tube 602 to join the air control system 500 in the previous irrigation device.

Also, in another part of the divider plate surface, there is another cylindrical tube 604 that extends upwards to the vicinity of the top end 206 of the tank. Tank water adjuster tubes 700 are movable inside this tube 604 like a piston in a syringe.

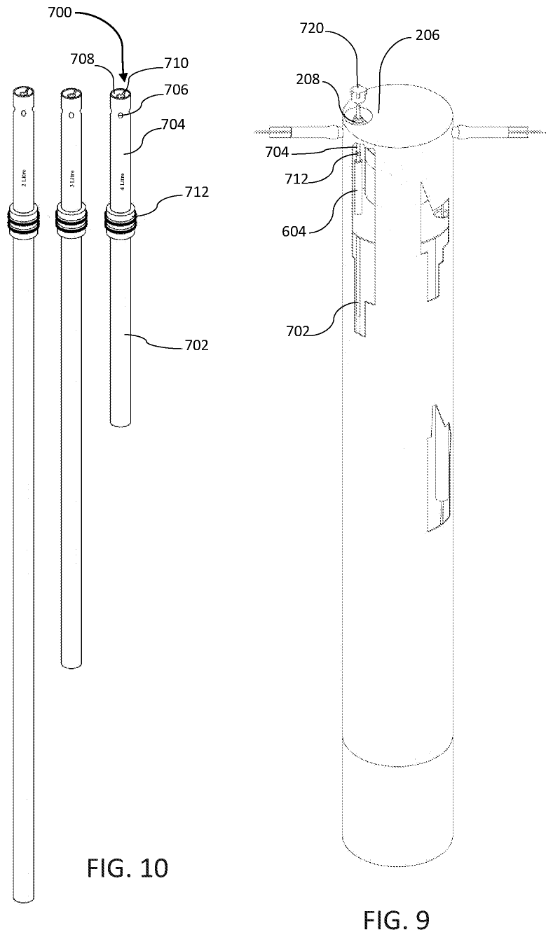

FIG. 9 is a view of the irrigation devices with a portion of the sidewall structure broken away to illustrate a perspective view of mounting of a tank water adjuster tube. According to this preferred embodiment of the present invention, a tank water adjuster tube 700 enters through an access vent 208 on the top end 206 of the tank into the irrigation device, so that one lower half 702 thereof passes through a cylindrical tube 604 in the divider plate but the upper half 704 of it remains under the top end 206 of the tank. A rubber gasket 712 that is attached onto the middle of the tank water adjuster tube 700 sits on the inner side walls of the cylindrical tube 604 and guarantees the lack of any air or water leakage through that tube. One cap 720, preferably a screw cap, then is screwed to the access vent 208 and completely closes it.

FIG. 10 is an overview of some preferable longitudinal sizes of tank water adjuster tube and its structure. According FIG. 10, a tank water adjuster tubes 700 can be in different longitudinal sizes and are selectable for each desirable level of water storage in the tank 200. Such a tank water adjuster tube 700 comprising: a) one lower half 702, as some preferred sizes are shown according FIG. 10, the longitudinal size of which, in proportion to the depth of the tank, is changeable and passes through the mentioned cylindrical tube 604 in the divider plate (FIG. 9) to the inside of the tank; b) one upper half 704 which is fixed in size and there are some holes 706 in one level on its sidewalls near the top end. The edges 708 of the upper end of this half have been folded inward, through which a slot 710 has been formed. Further, this half 704, as shown according to the FIG. 8, does not pass through the mentioned cylindrical tube 604 in the divider plate. c) one middle section having a rubber gasket 712 for guaranteeing the absence of probable leakage of air or water at the point of interconnection between the sidewalls of a tank water adjuster tube 700 sidewalls of the cylindrical tube 604 in the divider plate (Like a syringe piston, it can be moveable inside, but it prevents air from passing to the other side of the rubber gasket).

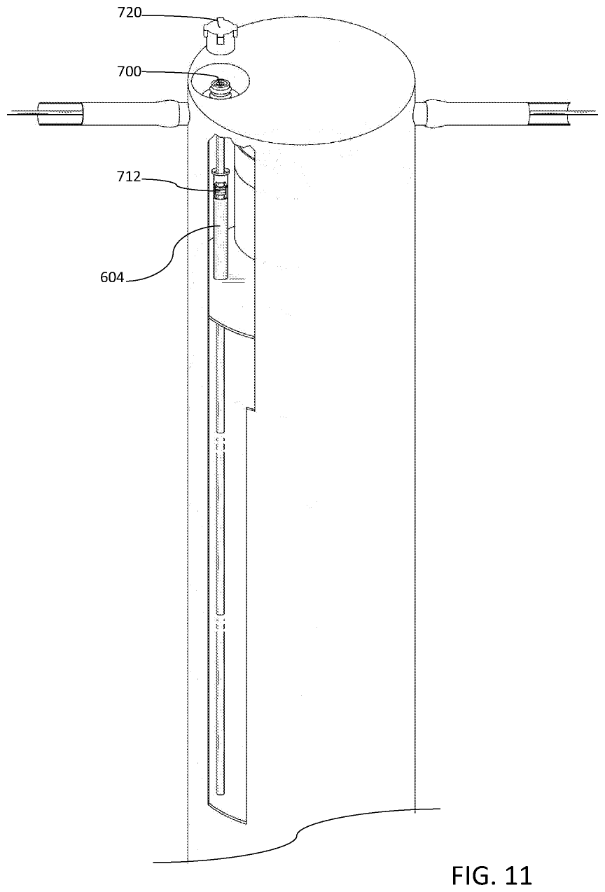

FIG. 11 shows a perspective view of the tank water adjuster tube in a position being assembled configuration in a irrigation device. According to this figure, the water adjuster tube 700 is installed in its proper place and the rubber gasket 712 is well placed on the inner wall of the cylindrical tube 604 to guarantee the absence of air or water leakage at the junction of the two, and also, the cap 720 is ready to be closed to the access vent at the upper end of the tank.

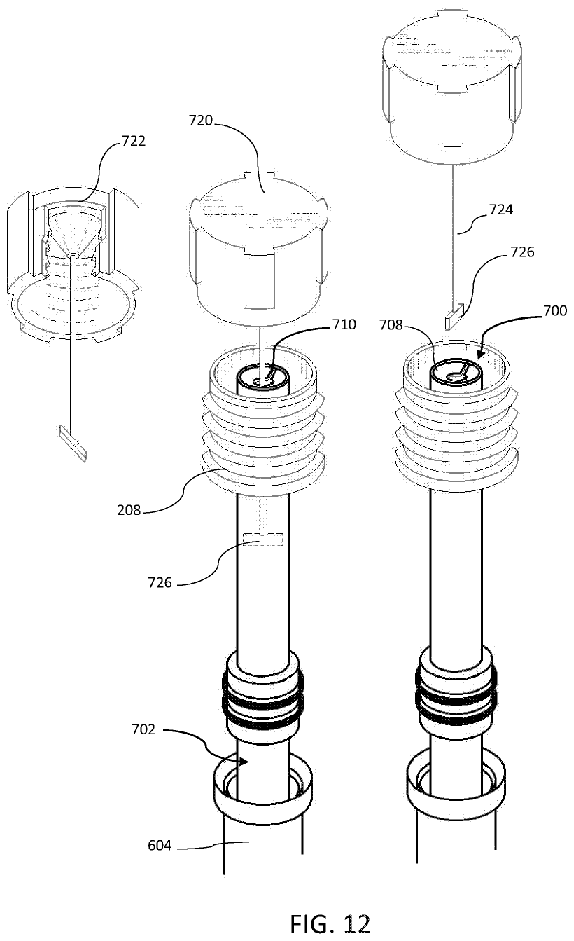

FIG. 12 shows an exploded perspective view of a preferable method of mounting a tank water adjuster cylindrical tube in a irrigation device and also an overview of a cap which is to be screwed to an access vent on the top of the irrigation device. According to the FIG. 12, A cap 720, preferably a screw cap, which is removably mounted to an access opening 208 on the top end of the tank and provides at least access to a tank water adjuster tube 700 for replacement. Such cap 720 comprising: a) one sealing ring 722 at the bottom in order for guaranteeing the absence of air of water leakage from inside of the irrigation device to the outside; b) one rod 724 one end of which is attached to the centre of the bottom of the cap 720 and the other end having a hook 726 to assist in pulling a tank water adjuster tube 700 out of the irrigation device; Such hook enters to inside of the tank water adjuster tube through a slot 710 provided in the top end of such tank water adjuster tube. After entering the hook into such tank water adjuster tube and with a slight rotation, the hook 726 will get stuck with folded inwards edges 708 of the top end of the tank water adjuster tube and then, with a little effort upwards it will pull that tube 700 out of the irrigation device.

A cap 720, according to the FIG. 12, has at least some key functions as follows: first, provides access to the tank water adjuster tube; Second, guarantees the absence of air or water leakage from the inside of the irrigation device to the outside; Third, assists in pulling the tank water adjuster tube out of the irrigation device as shown above.

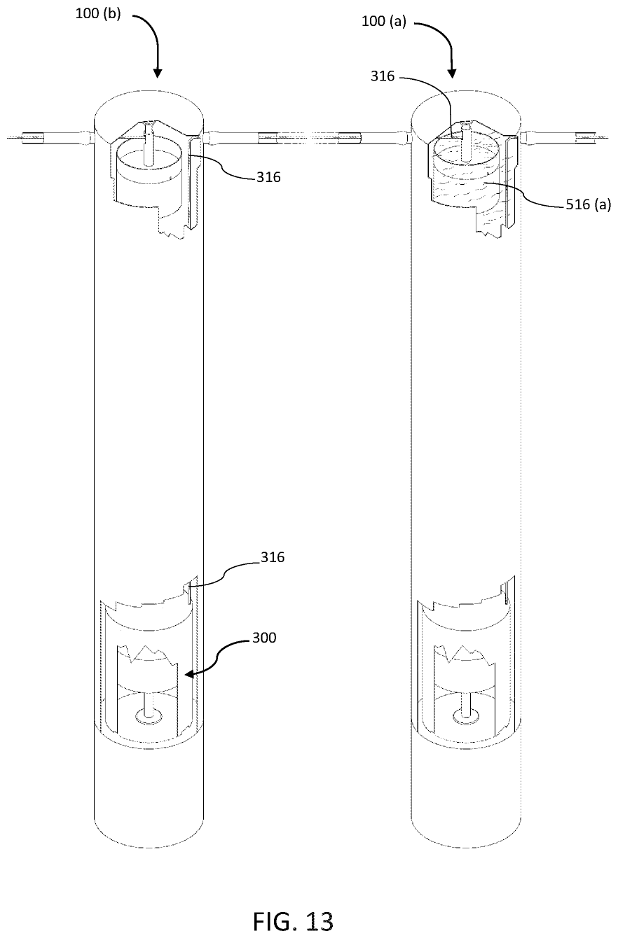

FIG. 13 is a perspective view of two irrigation devices without a tank water adjuster tube which are interconnected, in a situation the previous irrigation device of which is filled with water but it has not yet flowed into the next one. According to this figure, the tank of the previous irrigation device 100(a) is filled and has caused the float 516 (a) of the air control system in that irrigation device to move upwards, in which case the air outlet of the air hose 316 is blocked. In such situation, the air inside the blocking chamber 300 of the next irrigation device 100(b) will be trapped before the water flows into that device. As a result, water does not enter its blocking chamber 300 to drain out of that irrigation device.

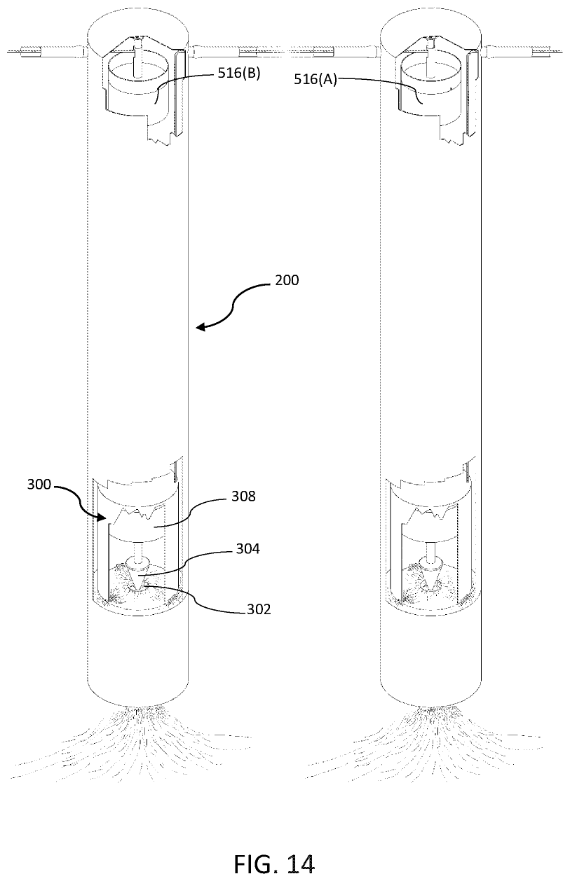

FIG. 14 is a perspective view of two irrigation devices without a tank water adjuster tube which are interconnected, in a situation where the floats 516 (A) & 516 (B) of their air control system are lowered and this has caused the trapped air to be released from the blocking chamber 300 and the water drain vent 302 to be opened. According to FIG. 14, the water inside the tanks is draining. This means that the air inside the blocking chamber of each irrigation devices has been released and the water from the tank 200 has entered to that chamber, in which case the float 308 of the chamber rises and raised the blocker 304 and as a result, has opened the water drain vent 302.

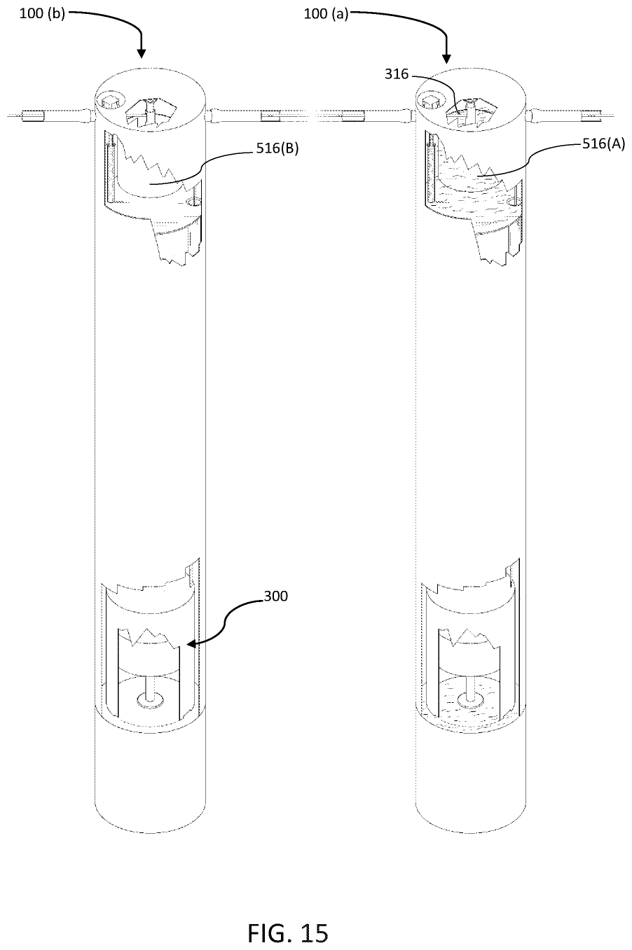

FIG. 15 is a perspective view of two irrigation devices with a tank water adjuster tube which are interconnected, in a situation the previous irrigation device of which is filled with water but it has not yet flowed into the next one. According to FIG. 15, the tank of the previous irrigation device 100(a) is filled and has caused the float 516(A) of the air control system in that irrigation device to be positioned upwards, in which case the air outlet of the air hose 316 is blocked. According to this figure, the water has not yet flowed into the next irrigation device 100 (b) and the float of the air control system of that device has been lowered and also the air inside the blocking chamber 300 of that irrigation device 100(b) will be trapped before the water flows into that device. As a result, water does not enter its blocking chamber 300 to drain out of that irrigation device.

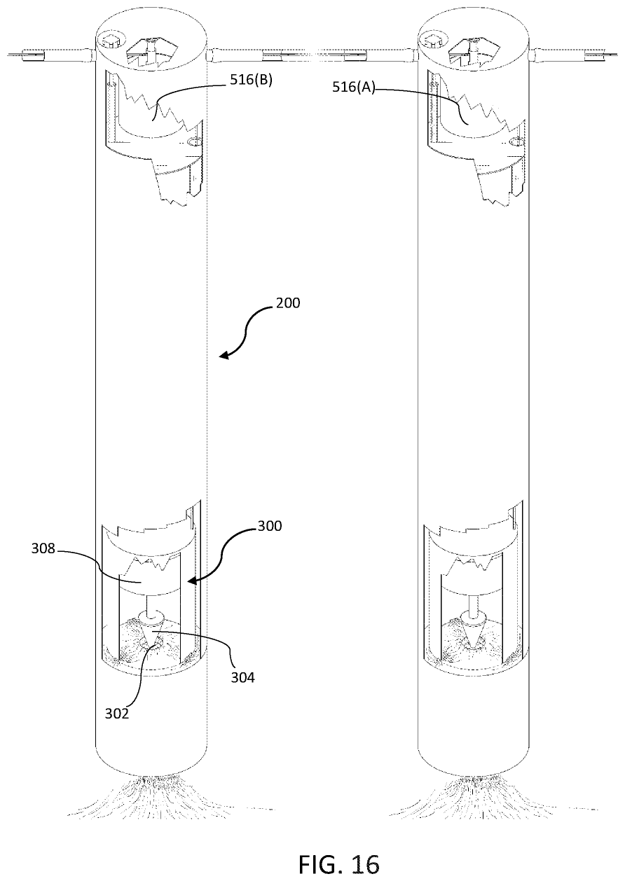

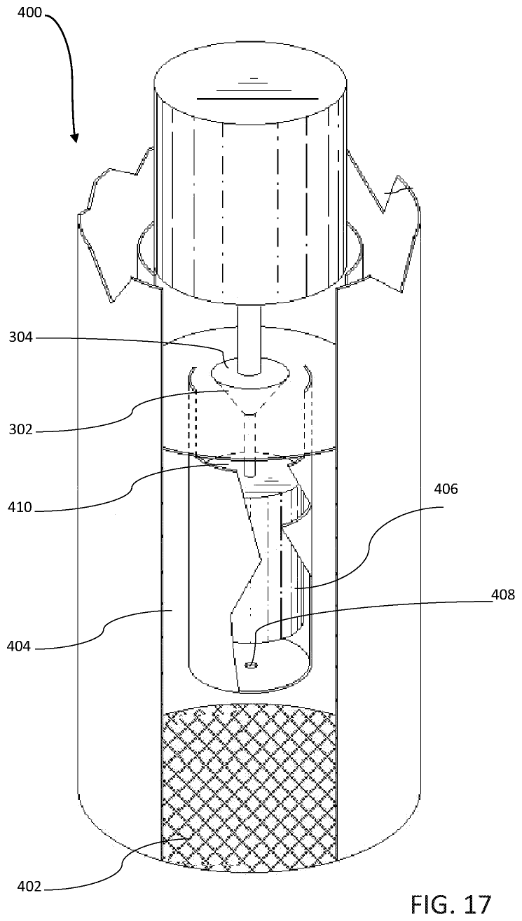

FIG. 16 is a perspective view of two irrigation devices with a tank water adjuster tube which are interconnected, in a situation where the floats 516 (A) & 516 (B) of their air control system are lowered and this has caused the trapped air to be released from the blocking chamber and the water drain vent to be opened. According to FIG. 16, the water inside the tanks is draining. This means that the air inside the blocking chamber 300 of each irrigation device has been released and the water from the tank 200 has entered to that chamber, in which case the float 308 of the chamber rises and raises the blocker 304 and opens the water drain vent 302.

FIG. 17 is a view of a hollow chamber with a portion of the sidewall structure broken away to illustrate constructions details thereof. According FIG. 17, one hollow chamber 400 is located at the lower section of the irrigation device so that the upper end thereof is the lower end of the tank. The lower end 402 of such a hollow chamber is a mesh plate, preferably spongy, to prevent dirt from entering the chamber. Such a chamber 400 is intended to create a hollow space 404 between the water drain vent 302 of the irrigation device and the soil for disconnecting a direct interface between them.

To further guarantee a fully drain water from the tank, it is preferable a float 406 to be put inside the hollow chamber. In this case, the top end of said float can reach and touch the bottom end(vertex) of the blocker 304 and pushes it upwards at the time of draining water so that the water is completely drained from the tank. Without this float 406, it would be possible that the blocker 304 is placed in the water drain vent 302 slightly earlier than the complete drain of water remaining in the tank. Said float 406, is preferably placed inside a chamber with a small hole 408 underneath and a larger vent 410 at the top. When draining water, most of water comes out of the larger vent at the top to keep the float at a higher level until the tank water is completely drained.

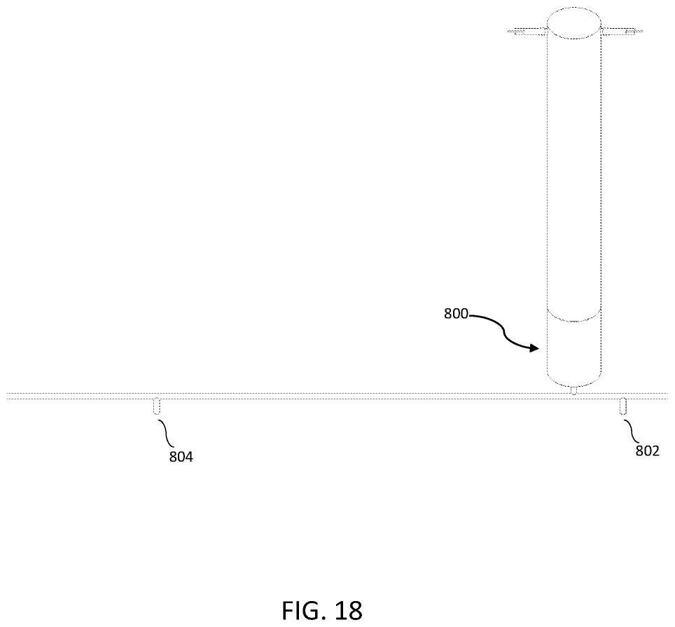

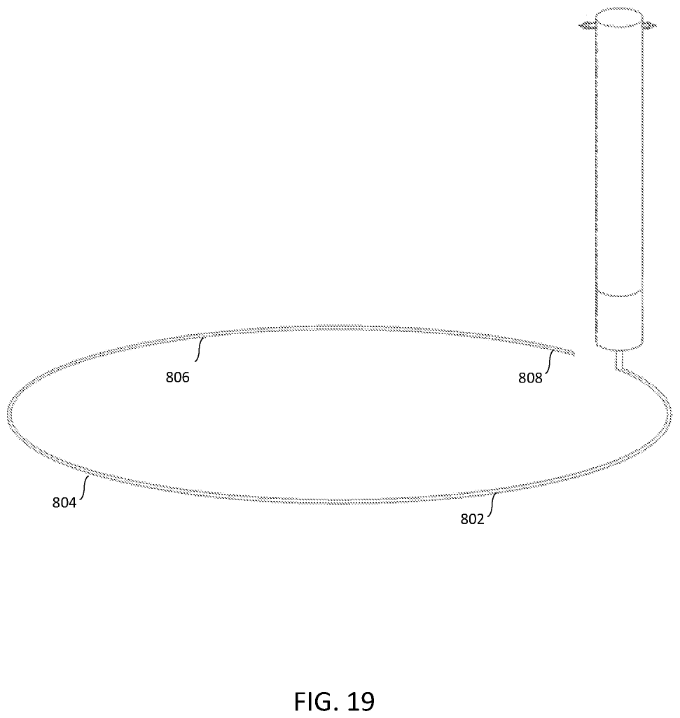

FIG. 18 shows a perspective view of a suggested alternative to the hollow chamber in order for dispersing water to more points. For this, another chamber 800, as an alternative to the hollow chamber, is attached to the lower section of the irrigation device so that a relatively long horizontal tube extends from the bottom thereof with more drain nozzles 802, 804 in different points thereof.

FIG. 19 shows a perspective view of one more suggested alternative to the hollow chamber in order for dispersing water to more points. For this, another chamber 800, as an alternative to the hollow chamber, is attached to the lower section of the irrigation device so that a relatively large ring tube extends from the bottom thereof with more drain nozzles 802, 804,806,808 in different points thereof.

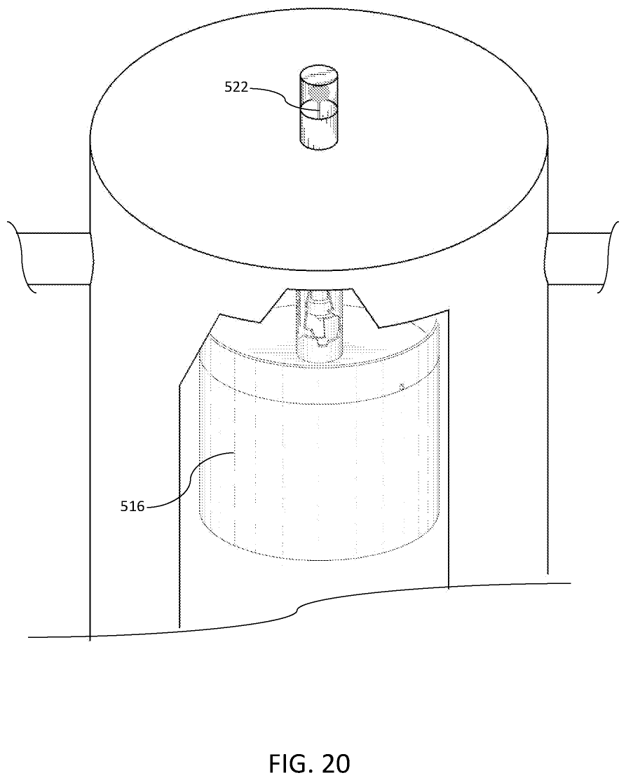

FIG. 20 is a view of an indicator by which the fullness or emptiness of the tank can be detected. According to this figure, a closed chamber is placed on top of the irrigation device, the lower half of which is opaque but the upper half of which is transparent. The connecting bar 522 of the air control system extends to the middle of the chamber and a coloured ball is placed on top of it. When the float 516 related to the air control system rises if the tank is full, it also raises the connecting bar and the mentioned ball comes out of the opaque half of the chamber and appears. Conversely, when the tank is empty, the float 516 goes down and the ball hides inside the opaque half of the chamber.

What is claimed is:

1- A subsurface flood irrigation system for trees and vines comprising irrigation devices (100), having tank, the irrigation system having the ability to automatically store and drain at least water, said irrigation devices (100) being connected in series with each other via a supply pipe(102), each irrigation device (100) comprising: a) one tank (200), in the form of a hollow cylindrical space at an upper portion of each said irrigation devices (100), for storing at least the required water inside said irrigation device; b) one blocking chamber (300), in the form of a cylindrical space, located inside said tank but at lower portion thereof, comprising an air outlet (316) for evacuating air from said blocking chamber (300) to block or open a water drain vent (302); c) one air control system (500), positioned at the upper interior of said tank (200), for blocking the air outlet from said blocking chamber located in a subsequent irrigation device; and, d) one hollow chamber (400) in the form of a cylindrical hollow space, located at the lower portion of said irrigation device, said hollow chamber (400) comprising two ends: an upper end connected to a lower end of said tank wherein said water drain vent (302) is in its center and, one bottom end having a mesh plate, preferably spongy.

2- An irrigation system according to claim 1, wherein said tank (200) comprising: a) one closed upper end (206); b) one bottom end (314), connected to one top end of said hollow chamber (400); c) one inlet tube (202), adjacent said one closed upper end; and, d) one outlet tube in front of said inlet tube (204), adjacent to said closed top end.

3- An irrigation system according to claim 1, wherein the required amount of water is adjustable, said tank (200) comprising: a) one closed top end (206), in one corner of which there is an access vent (208) with a cap (720), preferably a screw cap; b) one bottom end (314), connected to one top end of said hollow chamber (400); c) a divider plate (600), which divides said tank of the lowest part of said air control system (500) into two parts, upper and lower, and comprising: 1) a water inlet tube (602) to the lower part of said tank, which extends from the bottom of said divider plate downwards to the vicinity of said lower end of said tank; 2) a cylindrical tube (604), which extends from below said divider plate (600) directly upward to below said access vent (208); d) one inlet pipe (202), adjacent to said closed top end; and, e) one outlet pipe (204) in front of said inlet pipe, adjacent to said closed top end (206).

4- An irrigation system according to claim 3, wherein said tank (200) further comprises a tank water adjuster tube (700) of different longitudinal sizes, said tank water adjuster tube comprising: a) one lower half (702), for passing through said cylindrical tube (604) of said divider plate in which the longitudinal size is variable; b) one upper half (704), to be located below said access vent (208) of fixed longitudinal size, with some holes in one level on its sidewalls adjacent to its top end whose upper end edges are folded over inward in a way to form a slit; and, c) one middle section (712) having a rubber ring around it for guaranteeing the absence of probable leakage of air or water at the point of interconnection between the outer sidewalls of said tank water adjuster tube 700 and inner sidewalls of the cylindrical tube 604 in the divider plate mentioned in claim 3.

5- An irrigation system according to claim 3 or 4, wherein said cap (720), closable to said access vent (208) on the top end (206) of said tank (200) from the center of which a hooked rod extended out.

6- Irrigation system according to one of claims 1 to 5, in which the blocking chamber (300) comprises: a) one closed upper end (312); b) one open lower end, which is connected to said bottom end of said tank by the end of its sidewalls; c) at least one water inlet vent (310) from said tank into said blocking chamber at the junction of said bottom end (314) of said tank and said lower end of said blocking chamber; d) one float (308), movably positioned within said blocking chamber; e) one blocker (304), preferably of rubber, wherein the base portion is attached to the bottom end of said float with a connecting shaft (306); f) one water drain vent (302), positioned at the center of said one lower end of said blocking chamber or in other words, at the center of said bottom end (314) of said tank; and, g) one air hose (316), preferably with the smallest diameter, in which one end is positioned under said upper end (312) of said one blocking chamber and the other end is connected to said air control system (500) from the previous irrigation device, or alternatively, to an air valve (320).

7- Irrigation system according to one of claims 1 to 6, in which said air control system (500) is connected to an upper end (206) of said tank from the inner side, comprising: a) one air chamber (502) in the form of a vertical cylinder with both upper and lower closed ends, wherein one end of said air hose (316) after extending from said blocking chamber (300) leads into this air chamber through one of its said ends; b) one air nozzle (508), comprising two ends: one lower end which is inserted vertically into said air chamber through its upper end and one upper end which remains outside of said air chamber; c) one rubber piece (514), positioned inside said air chamber; d) one float (516); and, e) one connecting bar (522), one end of which is connected to one part of said float (516) and the other end is connected to the center of said rubber piece (514) after passing through said air nozzle (508).
